(19) United States
(12) Patent Application Publication
(10) Pub. No.: US 2024/0039025 A1
(43) Pub. Date: Feb. 1, 2024

(54) REBALANCING METHODS AND SYSTEMS FOR REDOX FLOW BATTERIES

(71) Applicant: UOP LLC, Des Plaines, IL (US)

(72) Inventors: Jinfeng Wu, Kildeer, IL (US); Stuart R. Miller, Arlington Heights, IL (US)

(21) Appl. No.: 18/296,105

(22) Filed: Apr. 5, 2023

Related U.S. Application Data
(60) Provisional application No. 63/369,682, filed on Jul. 28, 2022.

(51) Int. Cl. H01M 8/18

(52) U.S. Cl. CPC H01M 8/188

(57) ABSTRACT

Rebalancing methods and systems for redox flow battery systems are described. A reductant is selectively introduced from a reductant container into one or more of a rebalancing tank, the negative electrolyte tank, or the positive electrolyte tank to reduce Fe³⁺ ions to Fe²⁺ ions. The rebalancing system can be controlled by a controller in response to one or more measured properties of the iron flow battery.

### RELATED APPLICATIONS

This application claims priority to U.S. Provisional Patent Application Ser. No. 63/369,682 filed on Jul. 28, 2022, the entirety of which is incorporated herein by reference.

### BACKGROUND OF THE INVENTION

The large-scale integration of renewable energy derived from solar or wind sources into the electric grid requires robust energy storage systems to improve its reliability, power quality, and economy. Among various energy storage technologies that having been considered and explored, redox flow batteries (RFB) are unique because they can convert electrical energy into chemical potential energy by means of a reversible electrochemical reaction between two aqueous electrolyte solutions. In their simplest form, RFBs are electrochemical energy storage systems that reversibly convert chemical energy directly to electricity. They are typically composed of two external storage tanks filled with active materials comprising ions that may be in different valance states, two circulation pumps, and a flow cell with a porous separator which is located between the anode and the cathode and is used to separate the anolyte and the catholyte, as well as to utilize the current circuit by allowing the transfer of balancing ions. The anolyte, catholyte, anode, and cathode are commonly referred to as the negative electrolyte, positive electrolyte, negative electrode, and positive electrode, respectively. Therefore, the power and energy capacity can be independent, indicating that the storage capacity is determined by the quantity of electrolyte used and the rating power is decided by the active area as well as the number of the battery stacks.

Compared with the other redox flow battery technologies, such as all-vanadium redox flow battery, zinc-bromine redox flow battery, or iron-chromium redox flow battery, all iron redox flow batteries (IFB) are particularly attractive for grid scale storage applications because of their advantages, such as low chemical toxicity and very low material cost as a result of utilizing abundantly available iron, salt, and water as the electrolyte.

By using iron in different valence states in both the positive and negative sides of the IFB, contamination issues due to crossover are effectively eliminated. The iron-based positive and negative electrolyte solutions stored in the external storage tanks flow through the stacks of the batteries. In the positive side, the half-cell reaction involves ferrous ions (Fe²⁺) losing electrons to form ferric ions (Fe³⁺) during charge and Fe³⁺ gaining electrons to form Fe²⁺ during discharge. The positive reaction is given by Equation 1. For the negative side, the half-cell reaction involves the plating and stripping of iron in the form of a solid plate. The negative reaction is represented by Equation 2. The overall IFB reaction is shown in Equation 3.

Positive electrode: 2Fe²⁺↔2Fe³⁺+2e⁻ E⁰=+0.77V (1)

Negative electrode: Fe²⁺+2e⁻↔Fe⁰ E⁰=−0.44V (2)

Total: 3Fe²⁺↔Fe⁰+2Fe³⁺ E⁰=1.21V (3)

One of the challenges with IFB s is that their longevity relies on their capacity, which is prone to fading. IFB capacity loss occurs primarily due to the inevitable undesired side reactions such as H₂ evolution on the negative side of the battery. The continual generation of H₂ eventually leads to an imbalance in the electrolytes and a shift in electrolyte average oxidation state (AOS), since the plated amount of Fe ° from Fe²⁺ on the negative side reduces during charging while on the positive side there is still oxidation of Fe²⁺ to Fe²⁺, as shown in the Equations 4 and 5.

Negative electrode: 2H⁺+2e⁻ =H₂↑ E⁰=0V (4)

Total: 2Fe²⁺+2H⁺=2Fe³⁺+H₂↑ E⁰=0.77V (5)

Another reason for IFB efficiency decline and capacity loss may result from electrolyte and water crossover through the membrane. For example, ferric ions in the positive side may be driven toward the negative side by a ferric ion concentration gradient and an electrophoretic force across the membrane, while ferrous ions in the negative side may migrate to the positive side. The lack of ferrous ions in negative side accelerates the hydrogen evolution reaction (Equation 4) and exacerbates the battery state of health.

pH also plays a role in the optimal operation of an iron redox flow battery. If the pH of the negative electrolyte is too low, i.e., a high H⁺ concentration in solution, then the hydrogen evolution reaction is exacerbated during the charge cycle, resulting in poor coulombic efficiency and electrolyte pH imbalance. Similarly, if the pH of the negative electrolyte gets too high, then iron tends to precipitate out of solution as iron oxides and hydroxides. For example, in the operation of some IFBs, the ideal pHs of the positive and negative electrolytes are in the range of 0-1 and 4-5, respectively. The removal of iron from the solution in oxide and hydroxide forms results in a lower iron ion availability in solution, and consequently a reduction in available capacity at the anode side. Preferably, IFBs are operated with the negative solution in a very narrow pH window, such that it is as high as possible to limit the possibility to generate H₂ at the anode and as low as possible to avoid the unwanted formation of iron oxides and hydroxides.

To maintain the capacity of the battery, the excessive Fe³⁺ in the positive side in Equation 5 should be reduced back to Fe²⁺, and the proton loss and subsequent pH increase owing to H₂ evolution in the flow battery system need to be recovered simultaneously. The prior art answer is to react ferric ions with H₂ by utilizing chemical or electrochemical approaches to convert H₂ back to protons and reduce ferric ions to ferrous ions, as shown in Equation 6. A relative stable pH and state of charge (SOC) in both positive and negative electrolytes can be maintained as a result.

However, for both conventional chemical approaches, like trickle bed reactors and jelly roll reactors, and electrochemical approaches to rebalance the AOS, a catalyst comprising a supported precious metal (e.g., carbon-supported Pt, Pd, Rh, Ru, Ir, Ta or alloys thereof) is needed to promote and accelerate the reaction between the ferric ions in the IFB solution and hydrogen gas. For the chemical reaction at the three-phase boundary, mass transport losses in these reactors have been a longstanding problem. The general approach to compensate for the mass transport limitations has been to oversize the rebalancing reactors. However, oversizing the rebalancing reactors is costly, and it further suffers from poor catalyst utilization. For the electrochemical approach, an expensive membrane, such as a Nafion® membrane, a UOP redox membrane (URM), or other proton exchange separator is needed to transport protons between the positive and negative sides. An auxiliary electric controller system may also be needed. Furthermore, for chemical and electrochemical approaches, a custom-made electrolyte tank may be needed to retain the hydrogen pressure and send the hydrogen back to the hydrogen recombination reactor, combined with an external source of H₂ to compensate for leaks. The use of a custom-made high-pressure tank increases the cost of the system.

2Fe³⁺+H₂=2Fe²⁺+2H⁺ (6)

Therefore, there is a need for an improved method and system for rebalancing IFB s.

### BRIEF DESCRIPTION OF THE DRAWINGS

FIG. 1 is a process flow diagram of one embodiment of the refresh process for a redox flow battery with a rebalancing tank.

FIG. 2 is a process flow diagram of another embodiment of a refresh process for a redox flow battery with a rebalancing tank.

FIG. 3 is a process flow diagram of another embodiment of the refresh process for a redox flow battery with a rebalancing tank.

FIG. 4 is a process flow diagram of another embodiment of a refresh process for a redox flow battery.

FIG. 5 is a process flow diagram of another embodiment of the refresh process for a redox flow battery.

### DESCRIPTION OF THE INVENTION

The present invention discloses rebalancing methods and systems for redox flow battery systems to mitigate Fe³⁺ build-up on positive side, lower the system pH, reduce the level of impurities in electrolyte, and regain battery performance and efficiency. The benefits of method and system include, but are not limited to, simplifying the iron flow battery operation, improving the system health, reducing the frequency of system maintenance, and significantly lowering the cost of the iron flow 120 battery system.

Fe³⁺ solution has previously been used as a regulatory agent to control ppm-scale hydrogen sulfide (H₂S) in wastewater collection systems effectively. The test results indicated that the reduction of the dissolved H₂S was achieved up to nearly 100% in the neutral pH range, See e.g., T. C. Prathna and A. Srivastava, Ferric chloride for 125 odour control: studies from wastewater treatment plants in India. Water Practice and Technology, (2021) 16 (1): 35-41; N. Aslanidouet al., Regulatory agent for the reduction of hydrogen sulfide (H₂S) in municipal wastewater. International Conference on the Protection and Restoration of the Environment IX, Kefalonia, June 2008; B. Wood, Sewer sulphide control with ferrous chloride-a case study. 10^{th} Annual WIOA NSW Water Industry Operations Conference & Exhibition. Newcastle Jockey Club, April 2016: 131-136.

Hydrogen sulfide is utilized to reduce excessive ferric ions in the redox flow battery resulting from the undesirable side reaction. When hydrogen sulfide is passed through an acidified Fe³⁺ ions solution, as shown in Equation 7, some of the Fe²⁺ ions are reduced to Fe²⁺ by the sulfur ions coming from the H₂S, elemental sulfur precipitates, and hydrogen ions from the H₂S become protons. Unlike the prior art processes which require high-pressure hydrogen storage tanks and precious metal catalysts, the present invention does not require the precious metal catalysts or proton exchange membranes. When hydrogen sulfide is employed as the reducing agent in IFB systems, as shown in Equations 6 and 7, the detrimental effect of unavoidable hydrogen evolution including Fe³⁺ build-up in positive side and electrolyte pH imbalance change can be recovered.

2Fe₃₊+H₂S=2Fe²⁺+2H⁺+S↓ (7)

The operating conditions of the rebalancing tank, or the positive and/or negative electrolyte tanks when they are employed as the reduction reactors, are determined by trade-offs among reaction rate, electrolyte thermal stability, capital costs, and operating costs. Elevated temperature and pressure benefit H₂S absorption and the oxidation-reduction reaction between H₂S and Fe³⁺. Suitable electrolyte temperatures in the rebalancing tank include, but are not limited to, a range of −10 to 100° C., or −10 to 90° C., or −10 to 80° C., or −10 to 70° C., or −10 to 60° C., or −10 to 50° C., or 10 to 100° C., or 10 to 90° C., or 10 to 80° C., or 10 to 70° C., or 10 to 60° C., or 10 to 50° C., or 30 to 100° C., or 30 to 90° C., or 30 to 80° C., or 30 to 70° C., or 30 to 60° C., or 30 to 50° C. Suitable pressure ranges for the rebalancing tank include, but are not limited to, 0 to 6.9 MPa, or 0 to 1.0 MPa, or 0 to 5.0 MPa, or 0 to 4.0 MPa, or 0 to 3.0 MPa, or 0 to 2.0 MPa, or 0 to 1.0 MPa, or 0 to 0.9 MPa, or 0 to 0.8 MPa, or 0 to 0.7 MPa, or 0 to 0.6 MPa, or 0 to 0.5 MPa, or 0 to 0.4 MPa, or 0 to 0.3 MPa, or 0 to 0.2 MPa. To avoid air ingress and ferrous ion oxidation, the rebalancing tank may be purged with an inert gas. Suitable inert gases include, but are not limited to, nitrogen and/or argon.

One aspect of the invention is a method of rebalancing an iron flow battery. In one embodiment, the method comprises operating the iron flow battery. The iron flow battery comprises a negative electrode, a positive electrode, a separator positioned between the negative electrode and the positive electrode, a negative electrolyte tank, a flow of a negative electrolyte between the negative electrolyte tank and the negative electrode, and a positive electrolyte tank, a flow of positive electrolyte between the positive electrolyte tank and the positive electrode. A reductant is selectively introduced from a reductant container into one or more of a rebalancing tank, the negative electrolyte tank, or the positive electrolyte tank to reduce Fe³⁺ ions to Fe²⁺ ions.

In some embodiments, there is a separate rebalancing tank. In others, the reductant is introduced into the catholyte tank and/or the anolyte tank. The location where the reductant is introduced depends on the particular process being used.

In some embodiments, the reductant is H₂S.

In some embodiments, the method further comprises: measuring a property of the iron flow battery; and controlling a flow of the reductant to one or more of the rebalancing tank, or the negative electrolyte tank, or the positive electrolyte tank based on the measured property of the iron flow battery. The property can be one or more physical, chemical, or electrochemical property of the positive electrolyte, the negative electrolytes, and/or the battery stack. These properties include, but are not limited to, tank level, pressure drop (dP), electrolyte pH, concentration, turbidity, state of charge (SOC), stack voltage, current, resistance, pump motor current draw, electrolyte color, viscosity, density, conductivity, electrolyte flow rate, and the like. The property can be measured using one or more sensors appropriate for the property being measured.

In some embodiments, the method further comprises filtering the negative electrolyte, the positive electrolyte, or both in a filtration unit comprising a filter. In some embodiments, the filtration unit is positioned between the positive electrolyte tank and the positive electrode, or between the negative electrolyte tank and the negative electrode, or between the positive electrolyte tank and the rebalancing tank, or between the negative electrolyte tank and the rebalancing tank, or combinations thereof.

In some embodiments, the method further comprises collecting precipitate from the filtration unit in a precipitate collection tank. In some embodiments, the precipitate collection tank can also be connected to one or more of the positive electrolyte tank, the negative electrolyte tank, and/or the rebalancing tank, depending on the process.

In some embodiments, the rebalancing tank in selective bi-directional communication with the positive electrolyte tank, and the reductant tank is in selective communication with the rebalancing tank. The method may further comprise introducing a portion of the positive electrolyte to the rebalancing tank. The reductant is introduced into the rebalancing tank to reduce at least a portion of the Fe³⁺ ions in the positive electrolyte in the rebalancing tank to increase an amount of the Fe²⁺ ions in the positive electrolyte in the rebalancing tank. A portion of the positive electrolyte from the rebalancing tank having the increased amount of Fe²⁺ ions is introduced into the positive electrolyte tank.

In some embodiments, the rebalancing tank is in selective unidirectional downstream connection with the positive electrolyte tank, the negative electrolyte tank is in selective unidirectional downstream connection with the rebalancing tank, and the reductant tank is in selective communication with the rebalancing tank. The method may further comprise introducing a portion of the positive electrolyte to the rebalancing tank. The reductant is introduced into the rebalancing tank to reduce at least a portion of the Fe³⁺ ions in the positive electrolyte in the rebalancing tank to increase an amount of the Fe²⁺ ions in the positive electrolyte in the rebalancing tank. A portion of the positive electrolyte from the rebalancing tank having the increased amount of Fe²⁺ ions is introduced into the negative electrolyte tank.

In some embodiments, the rebalancing tank is in selective bi-directional connection with the positive electrolyte tank, and the negative electrolyte tank is in selective bi-directional connection with the rebalancing tank, and the reductant tank is in selective communication with the rebalancing tank. The method may further comprise introducing a portion of the positive electrolyte and a portion of the negative electrolyte to the rebalancing tank to form a mixed electrolyte. The reductant is introduced into the rebalancing tank to reduce at least a portion of the Fe³⁺ ions in the mixed electrolyte in the rebalancing tank to increase an amount of the Fe²⁺ ions in the positive electrolyte in the rebalancing tank. A first portion of the mixed electrolyte from the rebalancing tank having the increased amount of Fe²⁺ ions is introduced into the positive electrolyte tank and a second portion of the mixed electrolyte from the rebalancing tank having the increased amount of Fe²⁺ ions is introduced into the negative electrolyte tank.

In some embodiments, the reductant tank is in selective communication with the positive electrolyte tank. The method may further comprise introducing the reductant into the positive electrolyte tank to reduce at least a portion of the Fe³⁺ ions in the positive electrolyte in the positive electrolyte tank to increase an amount of the Fe²⁺ ions in the positive electrolyte in the positive electrolyte tank.

In some embodiments, the reductant tank is in selective communication with the positive electrolyte tank and the negative electrolyte tank. The method may further comprise introducing the reductant into the positive electrolyte tank to reduce at least a portion of the Fe²⁺ ions in the positive electrolyte in the positive electrolyte tank to increase an amount of the Fe²⁺ ions in the positive electrolyte in the positive electrolyte tank; or introducing the reductant into the negative electrolyte tank to reduce at least a portion of the Fe³⁺ ions in the negative electrolyte in the negative electrolyte tank to increase an amount of the Fe²⁺ ions in the negative electrolyte in the negative electrolyte tank; or both.

In some embodiments, the rebalancing tank comprises a multiphase chemical reactor. The reactor can be a single-stage reactor or a multistage reactor. Suitable single stage reactors include, but are not limited to, continuous stirred tank reactors, fluidized bed reactors, plug flow reactors, and bubble column reactors. Multistage reactors include at least two of these reactors, which can be the same type or different types.

In some embodiments, the multiphase reactor comprises a trickle bed reactor, a fluidized bed reactor, a bubble column reactor, or combinations thereof.

Another aspect of the invention is a rebalancing system for an iron flow battery. In one embodiment, the iron flow battery comprises a negative electrode, a positive electrode, a separator positioned between the negative electrode and the positive electrode, a negative electrolyte tank, a flow of a negative electrolyte between the negative electrolyte tank and the negative electrode, and a positive electrolyte tank, a flow of positive electrolyte between the positive electrolyte tank and the positive electrode. The rebalancing system may comprise a reductant container selectively connected to one of more of a rebalancing tank, the positive electrolyte tank, or the negative electrolyte tank, the reductant container comprising a reductant to reduce Fe³⁺ ions to Fe²⁺ ions.

In some embodiments, the rebalancing system further comprises a controller responsive to a measured property of the redox flow battery to selectively allow a flow of reductant to the positive electrolyte tank.

In some embodiments, the rebalancing system further comprises a filtration unit comprising a filter positioned between the positive electrolyte tank and the positive electrode, or between the negative electrolyte tank and the negative electrode, or between the positive electrolyte tank and the rebalancing tank, or between the negative electrolyte tank and the rebalancing tank, or combinations thereof. In some embodiments, the filtration unit further comprises a precipitation collection tank connected to the filter.

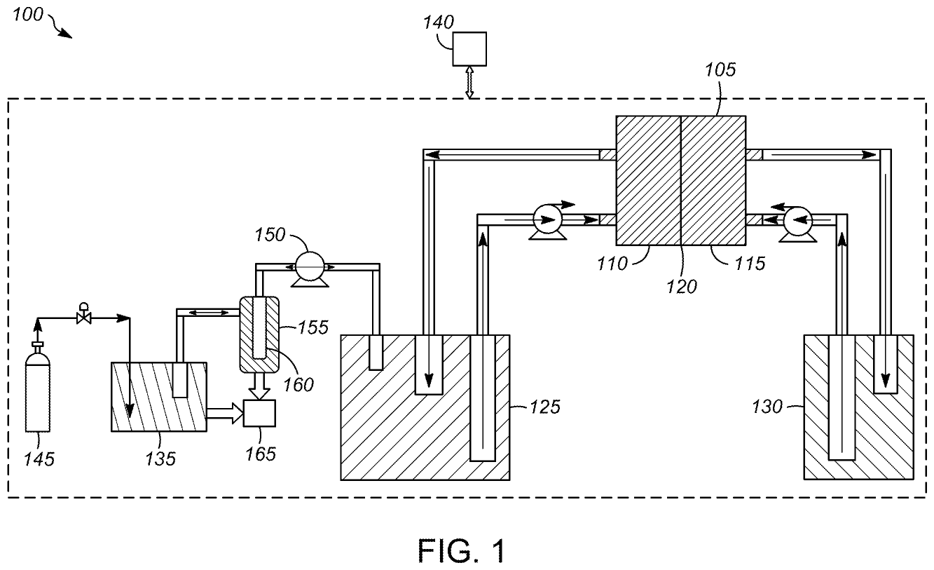

The SOC or Fe³⁺ concentration in the positive electrolyte can be adjusted by connecting the positive electrolyte tank to a separate rebalancing tank, as illustrated in FIG. 1. During operation of the IFB system, the physical, chemical, or electrochemical properties of the positive and negative electrolytes and the battery stack are monitored and controlled. These properties include, but are not limited to, tank level, electrolyte pH, concentration, turbidity, SOC, stack voltage, and the like. For example, when the state of charge, pH, or conductivity of the positive electrolyte is outside a predetermined operating range, a certain amount of positive electrolyte is pumped into the rebalancing tank. Sufficient hydrogen sulfide is then directed to the rebalancing tank to reduce the Fe³⁺ to Fe²⁺. After the rejuvenation of positive electrolyte in the rebalancing tank, the rebalanced positive electrolyte is returned to the IFB positive electrolyte tank. The SOC of the positive side is lowered as needed without any obvious effect on the total iron concentration or the electrolyte volume in the positive side. The proton loss and electrolyte pH increase ascribed to the hydrogen evolution can also be compensated for and recovered. The byproduct sulfur can be collected from the rebalancing tank and a filter unit that may be connected to the battery positive electrolyte tank.

The rebalancing method 100 illustrated in FIG. 1 includes an IFB stack 105 comprising a positive electrode 110, a negative electrode 115, and a separator 120. In operation, positive electrolyte flows from positive electrolyte tank 125 to the positive electrode 110 and back to the positive electrolyte tank 125, and negative electrolyte flows from negative electrolyte tank 130 to the negative electrode 115 and back to the negative electrolyte tank 130.

The positive electrolyte tank 125 is in selective bi-directional communication with a rebalancing tank 135. The system is monitored and controlled by controller 140 for one or more physical, chemical, or electrochemical properties which are measured by sensors (not shown). When one or more property(s) is outside of a predetermined operating range, the controller 140 allows positive electrolyte to flow from the positive electrolyte tank 125 to the rebalancing tank 135. A reductant from a reductant container 145 is introduced into the rebalancing tank 135 where it reduces Fe³⁺ to Fe²⁺. When a sufficient amount of Fe³⁺ has been reduced to Fe²⁺, the reductant flow is stopped, and the refreshed positive electrolyte is returned to the positive electrolyte tank 125. In some cases, a bidirectional pump 150 can be used to accomplish the positive electrolyte flow to and from the positive electrolyte tank.

In some processes, there is a filtration unit 155 comprising a filter 160 to remove precipitates from the positive electrolyte flowing between the positive electrolyte tank 125 and the rebalancing tank 135. There can be a precipitate collection tank 165 connected to the filtration unit 155. The precipitate collection tank 165 can also be connected to the rebalancing tank 135 to remove precipitates from the rebalancing tank 135, if desired.

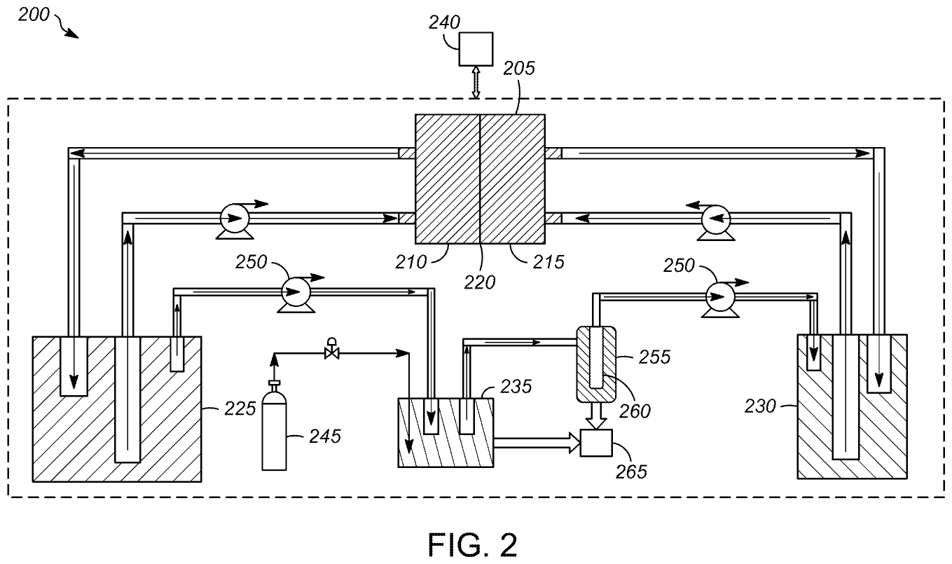

The rebalance design in FIG. 2 can be employed to address the ion crossover and pH imbalance issues during long-term operation. During the operation of IFB system, the properties of the positive and negative electrolytes and the battery stack are monitored and controlled, as discussed above. As an example, when the level gauge, ion concentration, or electrolyte pH in the positive or negative electrolyte tanks is triggered and the electrolyte becomes unbalanced between the positive and negative sides, a certain amount of positive electrolyte is pumped into the rebalancing tank. Then sufficient hydrogen sulfide is directed to the rebalancing tank to reduce the Fe³⁺ in the electrolyte. The refreshed acidic Fe²⁺ electrolyte in the rebalancing tank is then discharged to the negative electrolyte tank without concern about the formation of Fe(OH)₃ precipitate. The ion accumulation in the positive side and the pH increase in negative side can be corrected simultaneously. The byproduct sulfur can be collected from the rebalancing tank and the filter unit that are connected to the negative electrolyte tank.

The rebalancing method 200 illustrated in FIG. 2 includes an IFB stack 205 comprising a positive electrode 210, a negative electrode 215, and a separator 220. In operation, positive electrolyte flows from positive electrolyte tank 225 to the positive electrode 210 and back to the positive electrolyte tank 225, and negative electrolyte flows from negative electrolyte tank 230 to the negative electrode 215 and back to the negative electrolyte tank 230.

The rebalancing tank 235 is in selective unidirectional downstream communication with positive electrolyte tank 225 (i.e., the flow is from the positive electrolyte tank 225 to the rebalancing tank 235). The negative electrolyte tank 230 is in selective unidirectional downstream communication with the rebalancing tank 235 (i.e., the flow is from the rebalancing tank 235 to the negative electrolyte tank 230). The system is monitored and controlled by controller 240 for one or more physical, chemical, or electrochemical properties which are measured by sensors (not shown). When one or more property(s) is outside of a predetermined operating range, the controller 240 allows positive electrolyte to flow from the positive electrolyte tank 225 to the rebalancing tank 235. A reductant from a reductant container 245 is introduced into the rebalancing tank 235 where it reduces Fe³⁺ to Fe²⁺. When a sufficient amount of Fe³⁺ has been reduced to Fe²⁺, the reductant flow is stopped, and the refreshed 340 positive electrolyte is sent to the negative electrolyte tank 230. There can be a rebalancing pump 250 between the positive electrolyte tank 225 and the rebalancing tank 235, and another rebalancing pump 250 between the rebalancing tank 235 and the negative electrolyte tank 230, if desired.

In some processes, there is a filtration unit 255 comprising a filter 260 to remove precipitates from the positive electrolyte flowing between the rebalancing tank 235 and the negative electrolyte tank 230. There can be a precipitate collection tank 265 connected to the filtration unit 255. The precipitate collection tank 265 can also be connected to the rebalancing tank 235 to remove precipitates from the rebalancing tank 235, if desired.

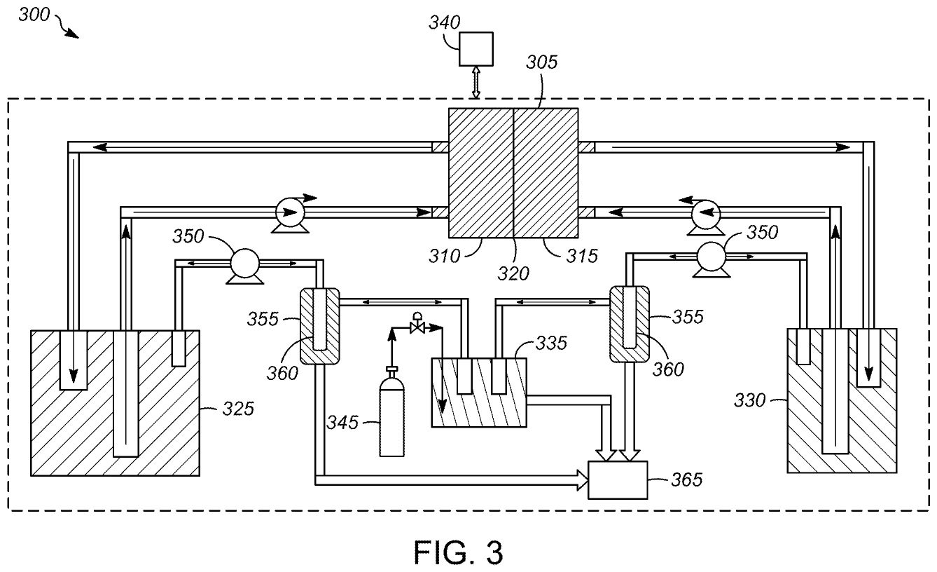

Ferric ions crossing over from the low pH positive side to the high pH negative side can result in precipitation of Fe(OH) 3 during IFB operation. The precipitation of Fe(OH)₃ can not only foul the membrane and cause severe battery capacity loss, but also block the flow channel, increase the flow resistance and IFB area specific resistance (ASR), and eventually lead to permanent damage to the IFB stack. As shown in FIG. 3, both the positive and negative electrolyte tanks are connected to a separate rebalancing tank through bidirectional pumps. Both positive electrolyte and negative electrolyte can be loaded to or discharged from the rebalancing tank separately or at the same time. During operation of the IFB system, the properties of the positive and negative electrolytes and the battery stack are monitored and controlled, as discussed above. For example, an increase in turbidity or pressure drop of the negative electrolyte may indicate the excessive crossover of Fe³⁺ from the positive side into the negative side. A certain amount of negative electrolyte is pumped into the rebalancing tank, and then sufficient hydrogen sulfide is directed into the rebalancing tank. After the loaded negative electrolyte is refreshed by the hydrogen sulfide, the acidic Fe²⁺ electrolyte is discharged back to the negative electrolyte tank. This process can be repeated until the turbidity of the negative electrolyte drops below the threshold. The sulfur will be captured in the rebalancing tank and two filter units that are connected to the IFB electrolyte tanks.

The rebalancing method 300 illustrated in FIG. 3 includes an IFB stack 305 comprising a positive electrode 310, a negative electrode 315, and a separator 320. In operation, positive electrolyte flows from positive electrolyte tank 325 to the positive electrode 310 and back to the positive electrolyte tank 325, and negative electrolyte flows from negative electrolyte tank 330 to the negative electrode 315 and back to the negative electrolyte tank 330.

The rebalancing tank 335 is in selective bi-directional communication with positive electrolyte tank 325. The negative electrolyte tank 330 is in selective bi-directional communication with the rebalancing tank 335. The system is monitored and controlled by controller 340 for one or more physical, chemical, or electrochemical properties which are measured by sensors (not shown). When one or more property(s) is outside of a predetermined operating range, the controller 340 allows either positive electrolyte to flow from the positive electrolyte tank 325 to the rebalancing tank 335 or negative electrolyte to flow from the negative electrolyte tank 330 to the rebalancing tank 335. A reductant from a reductant container 345 is introduced into the rebalancing tank 335 where it reduces Fe³⁺ to Fe²⁺. When a sufficient amount of Fe³⁺ has been reduced to Fe²⁺, the reductant flow is stopped. The refreshed electrolyte is sent to the positive electrolyte tank 325 and the negative electrolyte tank 330. There can be a rebalancing pump 350 between the positive electrolyte tank 325 and the rebalancing tank 335 and another pump 350 between the rebalancing tank 335 and the negative electrolyte tank 330, if desired.

In some processes, there is a filtration unit 355 comprising a filter 360 to remove precipitates from the refreshed electrolyte flowing between the rebalancing tank 335 and the positive electrolyte tank 325 and/or between the rebalancing tank 335 and the negative electrolyte tank 330. There can be a precipitate collection tank 365 connected to the filtration unit(s) 355. The precipitate collection tank 365 can also be connected to the rebalancing tank 335 to remove precipitates from the rebalancing tank 335, if desired.

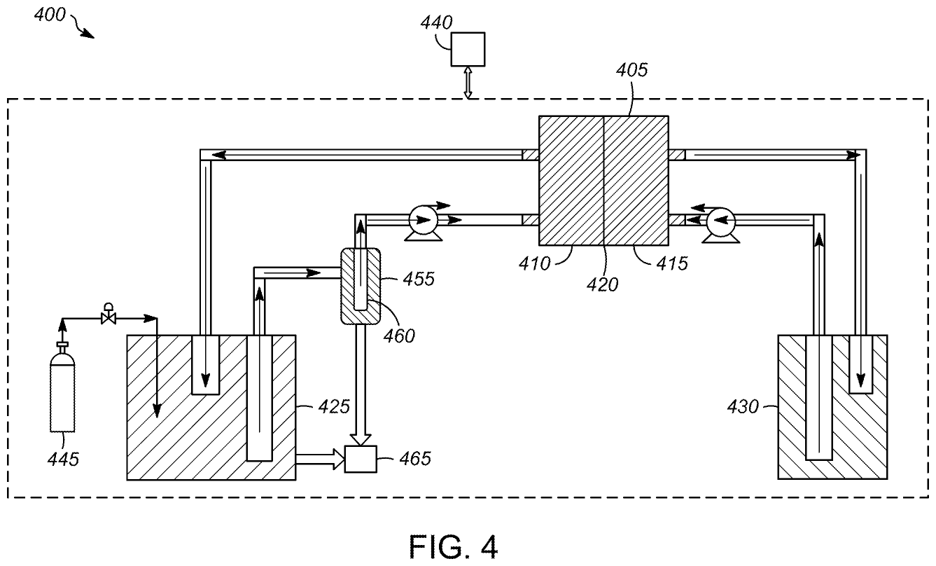

Besides being independent of each other, the rebalancing system and the battery system can be integrated and utilize at least one common component. During IFB operation, the SOC, pH, conductivity, or pressures of the positive and negative sides are monitored and acquired. As shown in FIG. 4, when any of these parameter threshold values is triggered, a certain amount of hydrogen sulfide is directly introduced into the positive electrolyte tank 425. The ferric ion concentration and the pH of the positive electrolyte will be adjusted accordingly. The sulfur precipitate is collected from the positive electrolyte tank and filtration unit before the battery stacks.

The rebalancing method 400 illustrated in FIG. 4 includes an IFB stack 405 comprising a positive electrode 410, a negative electrode 415, and a separator 420. In operation, positive electrolyte flows from positive electrolyte tank 425 to the positive electrode 410 and back to the positive electrolyte tank 425, and negative electrolyte flows from negative electrolyte tank 430 to the negative electrode 415 and back to the negative electrolyte tank 430.

In this embodiment, there is no rebalancing tank. A reductant from the reductant container 445 is introduced into the positive electrolyte tank 425 where it reduces Fe³⁺ to Fe²⁺. When a sufficient amount of Fe³⁺ has been reduced to Fe²⁺, the reductant flow is stopped.

The system is monitored and controlled by controller 440 for one or more physical, chemical, or electrochemical properties which are measured by sensors (not shown). When one or more property(s) is outside of a predetermined operating range, the controller 340 allows reductant to flow from the reductant container 445 to the positive electrolyte tank 425.

In some processes, there is a filtration unit 455 comprising a filter 460 to remove precipitates from the positive electrolyte flowing from the positive electrolyte tank 425. There can be a precipitate collection tank 465 connected to the filtration unit 455. The precipitate collection tank 465 can also be connected to the positive electrolyte tank 425 to remove precipitates from the positive electrolyte tank 425, if desired.

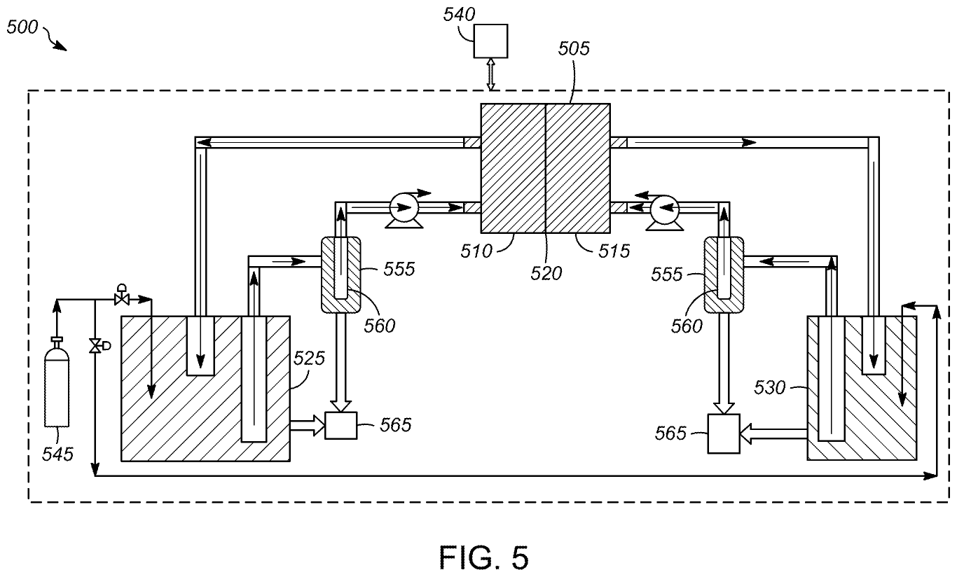

As illustrated in FIG. 5, when the parameter of the turbidity, pH, or pressure, for example, of the negative side is outside a predetermined operating range, a certain amount of hydrogen sulfide can be directly introduced into the negative electrolyte tank. The ferric ions crossing over from the positive side can be reduced to ferrous ions, reducing the possibility of Fe(OH)₃ precipitation in high pH negative side. The sulfur precipitate is collected from the positive and negative electrolyte tanks and the filtration units before the battery stacks.

The rebalancing method 500 illustrated in FIG. 5 includes an IFB stack 505 comprising a positive electrode 510, a negative electrode 515, and a separator 520. In operation, positive electrolyte flows from positive electrolyte tank 525 to the positive electrode 510 and back to the positive electrolyte tank 525, and negative electrolyte flows from negative electrolyte tank 530 to the negative electrode 515 and back to the negative electrolyte tank 530.

In this embodiment, there is no rebalancing tank. A reductant from the reductant container 545 is introduced into the positive electrolyte tank 525 and the negative electrolyte tank 530 where it reduces Fe³²⁺ to Fe²⁺. When a sufficient amount of Fe³⁺ has been reduced to Fe²⁺, the reductant flow is stopped.

The system is monitored and controlled by controller 540 for one or more physical, chemical, or electrochemical properties which are measured by sensors (not shown). When one or more property(s) is outside of a predetermined operating range, the controller 540 allows reductant to flow from the reductant container 545 to the positive electrolyte tank 525 and the negative electrolyte tank 530.

In some processes, there is a filtration unit 555 comprising a filter 560 to remove precipitates from the positive electrolyte flowing between the positive electrolyte tank 525 and the positive electrode 510 and/or between the negative electrolyte tank 530 and the negative electrode 515. There can be a precipitate collection tank 565 connected to the filtration unit(s) 555. The precipitate collection tank 565 can also be connected to the rebalancing tank 335 to remove precipitates from the rebalancing tank 335, if desired.

The integration of the rebalancing system and battery system as illustrated in FIGS. 4-5 can simplify the system design, reduce the physical footprint of the system, and reduce system cost. However, it has higher requirement for electrolyte tank and system sealing.

Hydrogen gas generated in an IFB anode side can be released to the environment after acid removal. The proton loss and consequent electrolyte pH increase due to hydrogen evolution can be compensated by employing the rebalancing system. The hydrogen sulfide in the rebalancing system can be stored in high-pressure gas cylinders. A hydrogen sulfide generator is an alternative for rebalancing IFB system when needed. It can generate hydrogen sulfide by the reaction between ferrous sulfide and hydrochloride, the reaction between inorganic material with water, including thioacetamide, or the reactions between metal or nonmetal sulfides and water, such as aluminum sulfide, phosphorus pentasulfide, or silicon disulfide. Sulfur captured in the electrolyte tanks and filter units is collected as a by-product. Alternatively, the hydrogen and sulfur could be combined to make hydrogen sulfide for recycling.

### Specific Embodiments

While the following is described in conjunction with specific embodiments, it will be understood that this description is intended to illustrate and not limit the scope of the preceding description and the appended claims.

A first embodiment of the invention is a method of rebalancing an iron flow battery comprising operating the iron flow battery comprising a negative electrode, a positive electrode, a separator positioned between the negative electrode and the positive electrode, a negative electrolyte tank, a flow of a negative electrolyte between the negative electrolyte tank and the negative electrode, and a positive electrolyte tank, a flow of positive electrolyte between the positive electrolyte tank and the positive electrode; selectively introducing reductant from a reductant container into one or more of a rebalancing tank, the negative electrolyte tank, or the positive electrolyte tank to reduce Fe³⁺ ions to Fe²⁺ ions. An embodiment of the invention is one, any or all of prior embodiments in this paragraph up through the first embodiment in this paragraph wherein the reductant is H₂S. An embodiment of the invention is one, any or all of prior embodiments in this paragraph up through the first embodiment in this paragraph further comprising measuring a property of the iron flow battery; and controlling a flow of the reductant to one or more of the rebalancing tank, or the negative electrolyte tank, or the positive electrolyte tank based on the measured property of the iron flow battery. An embodiment of the invention is one, any or all of prior embodiments in this paragraph up through the first embodiment in this paragraph further comprising filtering the negative electrolyte, the positive electrolyte, or both in a filtration unit comprising a filter. An embodiment of the invention is one, any or all of prior embodiments in this paragraph up through the first embodiment in this paragraph wherein the filtration unit is positioned between the positive electrolyte tank and the positive electrode, or between the negative electrolyte tank and the negative electrode, or between the positive electrolyte tank and the rebalancing tank, or between the negative electrolyte tank and the rebalancing tank, or combinations thereof. An embodiment of the invention is one, any or all of prior embodiments in this paragraph up through the first embodiment in this paragraph further comprising collecting precipitate from the filtration unit in a precipitate collection tank. An embodiment of the invention is one, any or all of prior embodiments in this paragraph up through the first embodiment in this paragraph wherein the rebalancing tank in selective bi-directional communication with the positive electrolyte tank, and wherein the reductant tank is in selective communication with the rebalancing tank, further comprising introducing a portion of the positive electrolyte to the rebalancing tank; introducing the reductant into the rebalancing tank to reduce at least a portion of the Fe³⁺ ions in the positive electrolyte in the rebalancing tank to increase an amount of the Fe²⁺ ions in the positive electrolyte in the rebalancing tank; and introducing a portion of the positive electrolyte from the rebalancing tank having the increased amount of Fe²⁺ ions into the positive electrolyte tank. An embodiment of the invention is one, any or all of prior embodiments in this paragraph up through the first embodiment in this paragraph wherein the rebalancing tank is in selective unidirectional downstream connection with the positive electrolyte tank, and wherein the negative electrolyte tank is in selective unidirectional downstream connection with the rebalancing tank, and wherein the reductant tank is in selective communication with the rebalancing tank, further comprising introducing a portion of the positive electrolyte to the rebalancing tank; introducing the reductant into the rebalancing tank to reduce at least a portion of the Fe³⁺ ions in the positive electrolyte in the rebalancing tank to increase an amount of the Fe²⁺ ions in the positive electrolyte in the rebalancing tank; introducing a portion of the positive electrolyte from the rebalancing tank having the increased amount of Fe²⁺ ions into the negative electrolyte tank An embodiment of the invention is one, any or all of prior embodiments in this paragraph up through the first embodiment in this paragraph wherein the rebalancing tank is in selective bi-directional connection with the positive electrolyte tank, and wherein the negative electrolyte tank is in selective bi-directional connection with the rebalancing tank, and wherein the reductant tank is in selective communication with the rebalancing tank, further comprising introducing a portion of the positive electrolyte and a portion of the negative electrolyte to the rebalancing tank to form a mixed electrolyte; introducing the reductant into the rebalancing tank to reduce at least a portion of the Fe²⁺ ions in the mixed electrolyte in the rebalancing tank to increase an amount of the Fe²⁺ ions in the positive electrolyte in the rebalancing tank; introducing a first portion of the mixed electrolyte from the rebalancing tank having the increased amount of Fe²⁺ ions into the positive electrolyte tank and a second portion of the mixed electrolyte from the rebalancing tank having the increased amount of Fe²⁺ ions into the negative electrolyte tank. An embodiment of the invention is one, any or all of prior embodiments in this paragraph up through the first embodiment in this paragraph wherein the reductant tank is in selective communication with the positive electrolyte tank, further comprising introducing the reductant into the positive electrolyte tank to reduce at least a portion of the Fe³⁺ ions in the positive electrolyte in the positive electrolyte tank to increase an amount of the Fe²⁺ ions in the positive electrolyte in the positive electrolyte tank. An embodiment of the invention is one, any or all of prior embodiments in this paragraph up through the first embodiment in this paragraph wherein the reductant tank is in selective communication with the positive electrolyte tank and the negative electrolyte tank, further comprising introducing the reductant into the positive electrolyte tank to reduce at least a portion of the Fe₃₊ ions in the positive electrolyte in the positive electrolyte tank to increase an amount of the Fe²⁺ ions in the positive electrolyte in the positive electrolyte tank; or introducing the reductant into the negative electrolyte tank to reduce at least a portion of the Fe³⁺ ions in the negative electrolyte in the negative electrolyte tank to increase an amount of the Fe₂₊ ions in the negative electrolyte in the negative electrolyte tank; or both. An embodiment of the invention is one, any or all of prior embodiments in this paragraph up through the first embodiment in this paragraph wherein the rebalancing tank comprises a multiphase reactor. An embodiment of the invention is one, any or all of prior embodiments in this paragraph up through the first embodiment in this paragraph wherein the multiphase reactor comprises a trickle bed reactor, a fluidized bed reactor, a bubble column reactor, or combinations thereof.

A second embodiment of the invention is a rebalancing system for an iron flow battery comprising a negative electrode, a positive electrode, a separator positioned between the negative electrode and the positive electrode, a negative electrolyte tank, a flow of a negative electrolyte between the negative electrolyte tank and the negative electrode, and a positive electrolyte tank, a flow of positive electrolyte between the positive electrolyte tank and the positive electrode, the rebalancing system comprising a reductant container selectively connected to one of more of a rebalancing tank, the positive electrolyte tank, or the negative electrolyte tank, the reductant container comprising a reductant to reduce Fe³⁺ ions to Fe²⁺ ions. An embodiment of the invention is one, any or all of prior embodiments in this paragraph up through the second embodiment in this paragraph further comprising a controller responsive to a measured property of the redox flow battery to selectively allow a flow of reductant to the positive electrolyte tank. An embodiment of the invention is one, any or all of prior embodiments in this paragraph up through the second embodiment in this paragraph further comprising a filtration unit comprising a filter positioned between the positive electrolyte tank and the positive electrode, or between the negative electrolyte tank and the negative electrode, or between the positive electrolyte tank and the rebalancing tank, or between the negative electrolyte tank and the rebalancing tank, or combinations thereof. An embodiment of the invention is one, any or all of prior embodiments in this paragraph up through the second embodiment in this paragraph wherein the filtration unit further comprises a precipitation collection tank connected to the filter.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method of rebalancing an iron flow battery comprising:
operating the iron flow battery comprising a negative electrode, a positive electrode, a separator positioned between the negative electrode and the positive electrode, a negative electrolyte tank, a flow of a negative electrolyte between the negative electrolyte tank and the negative electrode, and a positive electrolyte tank, a flow of positive electrolyte between the positive electrolyte tank and the positive electrode; and
selectively introducing reductant from a reductant container into one or more of a rebalancing tank, the negative electrolyte tank, or the positive electrolyte tank to reduce Fe³⁺ ions to Fe²⁺ ions.

2. The method of claim 1 wherein the reductant is H₂S.

3. The method of claim 1 further comprising:
measuring a property of the iron flow battery; and
controlling a flow of the reductant to one or more of the rebalancing tank, or the negative electrolyte tank, or the positive electrolyte tank based on the measured property of the iron flow battery.

4. The method of claim 1 further comprising:
filtering the negative electrolyte, the positive electrolyte, or both in a filtration unit comprising a filter.

5. The method of claim 4 wherein the filtration unit is positioned between the positive electrolyte tank and the positive electrode, or between the negative electrolyte tank and the negative electrode, or between the positive electrolyte tank and the rebalancing tank, or between the negative electrolyte tank and the rebalancing tank, or combinations thereof.

6. The method of claim 4 further comprising:
collecting precipitate from the filtration unit in a precipitate collection tank.

7. The method of claim 1 wherein the rebalancing tank in selective bi-directional communication with the positive electrolyte tank, and wherein the reductant tank is in selective communication with the rebalancing tank, further comprising:
introducing a portion of the positive electrolyte to the rebalancing tank;
introducing the reductant into the rebalancing tank to reduce at least a portion of the Fe³⁺ ions in the positive electrolyte in the rebalancing tank to increase an amount of the Fe²⁺ ions in the positive electrolyte in the rebalancing tank; and
introducing a portion of the positive electrolyte from the rebalancing tank having the increased amount of Fe²⁺ ions into the positive electrolyte tank.

8. The method of claim 1 wherein the rebalancing tank is in selective unidirectional downstream connection with the positive electrolyte tank, and wherein the negative electrolyte tank is in selective unidirectional downstream connection with the rebalancing tank, and wherein the reductant tank is in selective communication with the rebalancing tank, further comprising:
introducing a portion of the positive electrolyte to the rebalancing tank;
introducing the reductant into the rebalancing tank to reduce at least a portion of the Fe³⁺ ions in the positive electrolyte in the rebalancing tank to increase an amount of the Fe²⁺ ions in the positive electrolyte in the rebalancing tank; and
introducing a portion of the positive electrolyte from the rebalancing tank having the increased amount of Fe²⁺ ions into the negative electrolyte tank.

9. The method of claim 1 wherein the rebalancing tank is in selective bi-directional connection with the positive electrolyte tank, and wherein the negative electrolyte tank is in selective bi-directional connection with the rebalancing tank, and wherein the reductant tank is in selective communication with the rebalancing tank, further comprising:
introducing a portion of the positive electrolyte and a portion of the negative electrolyte to the rebalancing tank to form a mixed electrolyte;
introducing the reductant into the rebalancing tank to reduce at least a portion of the Fe³⁺ ions in the mixed electrolyte in the rebalancing tank to increase an amount of the Fe²⁺ ions in the positive electrolyte in the rebalancing tank; and
introducing a first portion of the mixed electrolyte from the rebalancing tank having the increased amount of Fe²⁺ ions into the positive electrolyte tank and a second portion of the mixed electrolyte from the rebalancing tank having the increased amount of Fe²⁺ ions into the negative electrolyte tank.

10. The method of claim 1 wherein the reductant tank is in selective communication with the positive electrolyte tank, further comprising:
introducing the reductant into the positive electrolyte tank to reduce at least a portion of the Fe³⁺ ions in the positive electrolyte in the positive electrolyte tank to increase an amount of the Fe²⁺ ions in the positive electrolyte in the positive electrolyte tank.

11. The method of claim 1 wherein the reductant tank is in selective communication with the positive electrolyte tank and the negative electrolyte tank, further comprising:
introducing the reductant into the positive electrolyte tank to reduce at least a portion of the Fe³⁺ ions in the positive electrolyte in the positive electrolyte tank to increase an amount of the Fe²⁺ ions in the positive electrolyte in the positive electrolyte tank; or
introducing the reductant into the negative electrolyte tank to reduce at least a portion of the Fe³⁺ ions in the negative electrolyte in the negative electrolyte tank to increase an amount of the Fe²⁺ ions in the negative electrolyte in the negative electrolyte tank; or
both.

12. The method of claim 1 wherein the rebalancing tank comprises a multiphase reactor.

13. The method of claim 12 wherein the multiphase reactor comprises a trickle bed reactor, a fluidized bed reactor, a bubble column reactor, or combinations thereof.

14. The method of claim 1 wherein operating conditions of the rebalancing tank include one or more of: an electrolyte temperature in a range of −10 to 100° C., or a pressure in the rebalancing tank in a range of 0 to 6.9 MPa, or an inert gas purge.

15. A rebalancing system for an iron flow battery comprising a negative electrode, a positive electrode, a separator positioned between the negative electrode and the positive electrode, a negative electrolyte tank, a flow of a negative electrolyte between the negative electrolyte tank and the negative electrode, and a positive electrolyte tank, a flow of positive electrolyte between the positive electrolyte tank and the positive electrode, the rebalancing system comprising:
a reductant container selectively connected to one of more of a rebalancing tank, the positive electrolyte tank, or the negative electrolyte tank, the reductant container comprising a reductant to reduce Fe³⁺ ions to Fe²⁺ ions.

16. The rebalancing system of claim 15 further comprising a controller responsive to a measured property of the redox flow battery to selectively allow a flow of reductant to the positive electrolyte tank.

17. The rebalancing system of claim 15 further comprising:
a filtration unit comprising a filter positioned between the positive electrolyte tank and the positive electrode, or between the negative electrolyte tank and the negative electrode, or between the positive electrolyte tank and the rebalancing tank, or between the negative electrolyte tank and the rebalancing tank, or combinations thereof.

18. The rebalancing system of claim 17 wherein the filtration unit further comprises a precipitation collection tank connected to the filter.

19. The method of claim 15 wherein operating conditions of the rebalancing tank include one or more of: an electrolyte temperature in a range of −10 to 100° C., or a pressure in the rebalancing tank in a range of 0 to 6.9 MPa, or an inert gas purge.
